(19) United States
(12) Patent Application Publication
(10) Pub. No.: US 2025/0306746 A1
(43) Pub. Date: Oct. 2, 2025

(54) IMAGE DISPLAY METHOD

(71) Applicant: JVCKENWOOD Corporation, Yokohama-shi (JP)

(72) Inventor: Yasuhiko Suzuki, Yokohama-shi (JP)

(21) Appl. No.: 18/892,062

(22) Filed: Sep. 20, 2024

(30) Foreign Application Priority Data
Mar. 27, 2024 (JP) 2024-051972

(51) Int. Cl. G06F 3/04845; G06F 3/041; G06F 3/0488

(52) U.S. Cl. CPC G06F 3/04845; G06F 3/0412; G06F 3/04146; G06F 3/0488

(57) ABSTRACT

An information processing apparatus including a display unit provided with a display and a touch panel and a control unit configured to form a manipulation unit to be contact-manipulated by a user in a partial region of an obverse side of the display unit, the display including a display screen on which a manipulation face image including at least one manipulation image is to be displayed, the touch panel being configured to detect a contact manipulation of the user on the manipulation image, includes a manipulation unit control step of deforming the partial region such that the manipulation unit is formed in the partial region or such that the partial region, in which the manipulation unit is formed, is returned to an original state before formation of the manipulation unit.

### CROSS REFERENCE TO RELATED APPLICATION

This application is based upon and claims the benefit of priority from Japanese patent application No. 2024-051972, filed on Mar. 27, 2024, the disclosure of which is incorporated herein in its entirety by reference.

### BACKGROUND

The present disclosure relates to an image display method.

There is known a method for forming a manipulation unit (physical button) to be contact-manipulated by a user in a partial region of an obverse side of a display unit including a display and a touch panel under control from a control unit (or returning a partial region in which a physical button is formed to an original state before manipulation unit formation (see, for example, Patent Literature 1 and Non-Patent Literature 1.

[Patent Literature 1] Published Japanese Translation of PCT International Publication for Patent Application, No. 2011-508935

[Non-Patent Literature 1] https://drive.google.com/file/d/1--KfMTvkerEldZxiXC6Uf-zRVMtbA6YY/view

### SUMMARY

However, in Patent Literature 1 and Non-Patent Literature 1, no regard is given to the idea of displaying an image in relation to a manipulation unit (physical button) to be formed in a partial region of an obverse side of a display unit. There is room for improvement in this respect.

In an image display method according to an embodiment of the present disclosure, an information processing apparatus including a display unit provided with a display and a touch panel and a control unit configured to form a manipulation unit to be contact-manipulated by a user in a partial region of an obverse side of the display unit, the display including a display screen on which a manipulation face image including at least one manipulation image is to be displayed, the touch panel being configured to detect a contact manipulation of the user on the manipulation image, includes a manipulation unit control step of deforming the partial region such that the manipulation unit is formed in the partial region or such that the partial region, in which the manipulation unit is formed, is returned to an original state before formation of the manipulation unit, a manipulation face image display step of displaying the manipulation face image on the display screen in a state where the manipulation image is aligned so as to coincide with the manipulation unit, and a contact manipulation detection step of detecting the contact manipulation of the user on the manipulation unit.

### BRIEF DESCRIPTION OF THE DRAWINGS

The above and other aspects, advantages and features will be more apparent from the following description of certain embodiments taken in conjunction with the accompanying drawings, in which:

FIG. 1 is a schematic configuration diagram of an information processing apparatus 1 which implements an image display method according to an embodiment;

FIG. 2 shows one example (a sectional view) of a display unit 11; FIG. 3 shows one example of a program and the like stored in a storage unit 12;

FIG. 4 is a view representing how a manipulation face image 12a2 is displayed on a display 11b (a display screen) in a state where a button image b designated by button image designation information 12a3 is aligned so as to coincide with a physical button B;

FIG. 5 shows a flowchart of operational example 1 (an image display method) of the information processing apparatus 1;

FIG. 6 shows a flowchart of operational example 2 (an image display method) of the information processing apparatus 1;

FIG. 7 shows how the manipulation face image 12a2 is displayed on the display 11b (the display screen) in a state where the button image b designated by the button image designation information 12a3 is aligned so as to coincide with the physical button B;

FIG. 8 is a flowchart of operational example 3 (an image display method) of the information processing apparatus 1;

FIG. 9A shows one example of the physical button B to be formed in a partial region A of an obverse side of the display unit 11 that is to be used in operational example 3;

FIG. 9B shows one example of a game image HT1 to be displayed in a partial region of the display 11b (the display screen); and

FIG. 9C shows one example of a game image HT2 to be displayed in an entire region of the display 11b (the display screen).

### DETAILED DESCRIPTION

An information processing apparatus 1 which implements an image display method according to an embodiment will be described below with reference to the accompanying drawings. Corresponding constituent elements in the drawings are denoted by identical reference numerals, and a repetitive description thereof will be omitted.

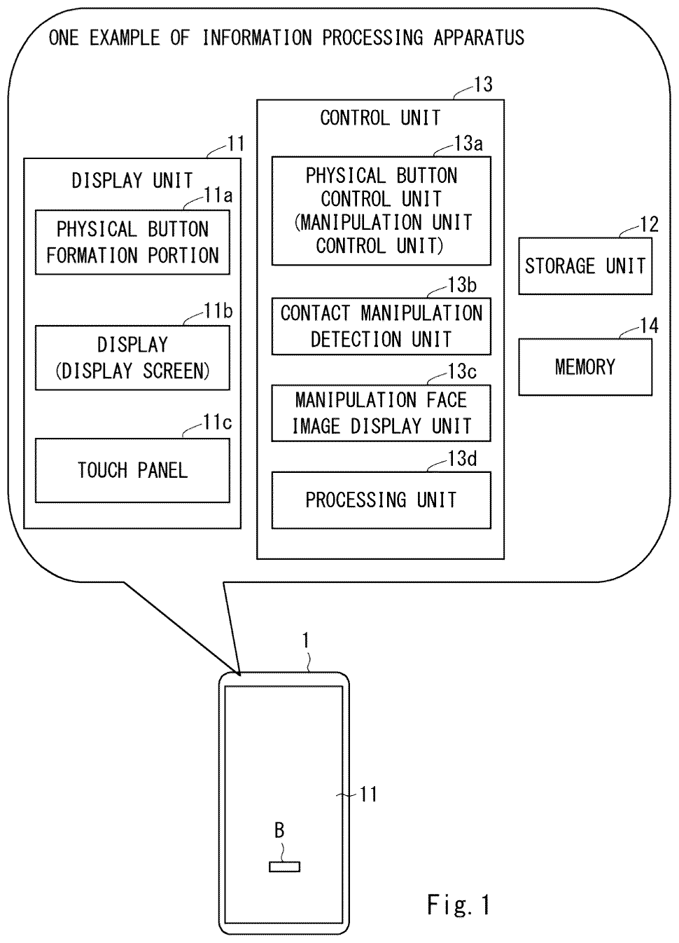

FIG. 1 is a schematic configuration diagram of the information processing apparatus 1 that implements the image display method according to the embodiment.

The image display method of the embodiment is implemented in the information processing apparatus 1. The information processing apparatus 1 is, for example, a smartphone which is carried by a user or a navigation apparatus which is mounted on a vehicle. The information processing apparatus 1 has a function of forming a physical button B (one example of a manipulation unit of the present disclosure) to be contact-manipulated by a user in a partial region of an obverse side (a physical button formation portion 11a) of a display unit 11 and a function of returning a partial region in which the physical button B is formed to an original state before formation of the physical button B. Specifically, the information processing apparatus 1 is configured in the following manner.

As shown in FIG. 1, the information processing apparatus 1 includes the display unit 11, a storage unit 12, a control unit 13, and a memory 14.

The display unit 11 includes the physical button formation portion 11a, a display 11b, and a touch panel 11c.

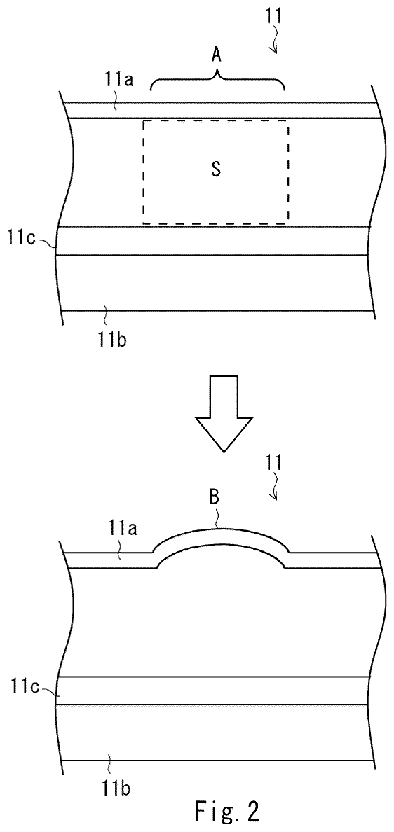

FIG. 2 shows one example (a sectional view) of the display unit 11.

As shown in FIG. 2, the physical button formation portion 11a and the touch panel 11c are located with an overlap above and on the display 11b. The display 11b includes a display screen on which a manipulation face image 12a2 (see, for example, FIG. 3) including at least one manipulation image b is to be displayed.

Various types of images (e.g., a manipulation face image and a game image) are displayed on the display 11b (the display screen), in addition to the manipulation face image 12a2 including the manipulation image b. The user visually recognizes the various types of images displayed on the display 11b (the display screen) via the physical button formation portion 11a and the touch panel 11c. The touch panel 11c detects a contact manipulation (a manipulation, such as a tap, a slide, a flick, a swipe, pinching-in, or pinching-out) of the user. Although a capacitive touch sensor is often adopted as the touch panel 11c, the touch panel 11c may be composed of, e.g., a transparent high-sensitivity pressure sensor or may be composed of an object combining both sensors. This configuration allows, for example, simultaneous detection of a position at which a surface of a partial region A is touched (electrostatic touch sensing) and a push-in (pressure sensing). In the display unit 11, a haptic sheet may be further located underneath the display 11b to offer feedback on, e.g., various types of contact manipulations (not shown).

The physical button B (e.g., a convex button or a concave button, one example of the manipulation unit of the present disclosure) to be contact-manipulated by the user is formed in the partial region A of the obverse side (the physical button formation portion 11a) of the display unit 11. This is realized by, for example, the control unit 13 (a physical button control unit 13a) controlling an actuator (not shown) to deform (uplift or sink) the partial region A of the obverse side (the physical button formation portion 11a) of the display unit 11. For example, the actuator is, for example, a microfluidic pump (not shown) and is connected to a hollow portion S between the partial region A (a fixed region defined in advance in which the physical button B is to be formed) of the obverse side (the physical button formation portion 11a) of the display unit 11 and the touch panel 11c via a channel (not shown).

Since the obverse side (the physical button formation portion 11a) of the display unit 11 is an elastically deformable layer portion, if the control unit 13 (the physical button control unit 13a) controls the actuator, moves (supplies) a fluid to the hollow portion S via the channel, and increases a volume, the partial region A of the obverse side (the physical button formation portion 11a) of the display unit 11 that corresponds to the hollow portion S is pushed up. For this reason, the partial region A of the obverse side (the physical button formation portion 11a) of the display unit 11 is uplifted, and the physical button B to be contact-manipulated by the user is formed (see FIG. 2).

On the other hand, if the control unit 13 (the physical button control unit 13a) controls the actuator, moves (discharges) a fluid from the hollow portion S to the outside via the channel, and decreases the volume, the partial region A of the obverse side (the physical button formation portion 11a) of the display unit 11 that corresponds to the hollow portion S returns to an original state (e.g., a flat state) before formation of the physical button B.

As described above, the physical button B to be contact-manipulated by the user is formed in the partial region A of the obverse side (the physical button formation portion 11a) of the display unit 11 including the display 11b and the touch panel 11c (or the partial region A, in which the physical button B is formed, is returned to an original state before formation of the physical button B) under control from the control unit 13 (the physical button control unit 13a). As means for realizing this, for example, Published Japanese Translation of PCT International Publication for Patent Application, No. 2011-508935 and flat panel haptics (https://drive.google.com/file/d/1--KfMTvkerEldZxiXC6Uf-zRVMtbA6YY/view) can be used.

Although the shape (outer shape) of the physical button B is, for example, a rectangular shape, as shown in FIG. 1, the shape is not limited to this and may be a circular shape, a cross shape, or any other shape. The number of physical buttons B may be one or more.

The storage unit 12 is a non-volatile storage unit, such as an SSD or a ROM.

FIG. 3 shows one example of a program and the like stored in the storage unit 12.

As shown in FIG. 3, an application 12a (application software, hereinafter also referred to as the app 12a), an OS 12b (an operating system), and hardware profile information 12c are stored in the storage unit 12.

The app 12a is mainly composed of a program 12a1, the manipulation face image 12a2, button image designation information 12a3, and available physical button information 12a4.

The program 12a1 may be anything as long as the program 12a1 is a program having a function of displaying the manipulation face image 12a2 on the display 11b (the display screen). Specific examples of the program 12a1 are, for example, a game program (for, e.g., a smartphone), and a navigation program (for, e.g., a navigation apparatus).

The manipulation face image 12a2 includes the manipulation image b to be contact-manipulated via the touch panel 11c by the user. Specific examples of the manipulation face image 12a2 are, for example, a remote control image, a game image, and a window image. Specific examples of the manipulation image b are a button image included in a remote control image, a button image (e.g., a cross-shaped button image) displayed together with a game image, and a button image for closing a window image which is included in the window image. The manipulation image b will hereinafter also be referred to as the button image b. Note that the manipulation image b is not limited to a button image and may be a key image or a slider image.

Although the shape (outer shape) of the manipulation face image 12a2 is, for example, a rectangular shape, as shown in FIG. 3, the shape is not limited to this and may be a circular shape or any other shape. The size of the manipulation face image 12a2 may be the same as that of the display 11b (the display screen), larger than that of the display 11b (the display screen), or smaller than that of the display 11b (the display screen). The number of manipulation face images 12a2 may be, for example, one, or a plurality of images may be collected as shown in FIG. 3.

Although the shape (outer shape) of the button image b is, for example, a triangular shape or a circular shape, as shown in FIG. 3, the shape is not limited to this and may be a rectangular shape, a cross shape, or any other shape. The shape (outer shape) of the button image b may be a shape tailored to the shape (outer shape) of the physical button B or a shape not corresponding to the shape (outer shape) of the physical button B. The size of the button image b may be the same as the size of the physical button B, larger than the size of the physical button B, or smaller than the size of the physical button B. The number of button images b may be, for example, one or more.

The button image designation information 12a3 (one example of manipulation image designation information of the present disclosure) is information designating the button image b to be aligned with the physical button B to be formed in the partial region A of the obverse side (the physical button formation portion 11a) of the display unit 11. The button image b designated by the button image designation information 12a3 is, for example, a button image corresponding to a main manipulation button or a button image corresponding to a most frequently manipulated button. A button image designated by the button image designation information 12a3 may be set by the user or may be automatically set by the app 12a or the like through predetermined image processing, such as image recognition, on the manipulation face image 12a2 or giving of additional data to the manipulation face image 12a2.

Specific examples of a main manipulation button image or a most frequently manipulated button image designated by the button image designation information 12a3 are a playback button image included in a remote control image, a cross-shaped button image displayed together with a game image, and a button image for closing a window image which is included in the window image.

The available physical button information 12a4 (one example of available manipulation unit information of the present disclosure) is information regarding a physical button (a physical button to be formed in a partial region of an obverse side (a physical button formation portion) of a display unit) available to the app 12a. The available physical button information 12a4 is used in the information processing apparatus 1, on which the app 12a is installed, to judge whether the physical button B to be formed in the partial region A of the obverse side (the physical button formation portion 11a) of the display unit 11 in the information processing apparatus 1 is available to the app 12a.

For example, the available physical button information 12a4 includes information (metadata of a UI element described in, e.g., HTML, CSS, or XML format) regarding a location, operation, and an attribute of a physical button available to the app 12a.

The location is, for example, information representing a location on the display (e.g., a region in which a physical button available to the app 12a is to be formed) of the physical button. The location may include, for example, information (e.g., the right side, the center, or the left side, or the top, the middle, or the bottom) about a rough position on the screen, and a maximum/minimum display size, scaling to which is allowed. The operation is, for example, information representing an operation when the physical button available to the app 12a is contact-manipulated. For example, the operation may include information, such as a margin for a contact manipulation or a touch sensitivity. The attribute may include information representing the type (e.g., a cross-shaped button, ABXY buttons, a stick-shaped button, or a slider-shaped button) of the physical button available to the app 12a and information designating presence or absence of pressure sensing in the physical button available to the app 12a.

The hardware profile information 12c is information regarding the physical button B to be formed in the partial region A of the obverse side (the physical button formation portion 11a) of the display unit 11 and includes information regarding a location, operation, and an attribute of the physical button B. The hardware profile information 12c may be a part of the OS 12b.

The location is, for example, information representing a location (e.g., a region in which the physical button B is to be formed) on the display 11b of the physical button B. The operation is, for example, information representing an operation when the physical button B is contact-manipulated. The attributes may include information representing the shape (e.g., a cross-shaped button, ABXY buttons, a stick-shaped button, or a slider-shaped button) of the physical button B or information representing hardware support of presence or absence of pressure sensing in the physical button B.

Although not shown, the control unit 13 includes a processor. The processor is, for example, a CPU (Central Processing Unit). The number of processors may be one or more. The processor executes the OS 12b and the program 12a1 that are loaded from the storage unit 12 into the memory 14 (e.g., a RAM), thereby functioning as the physical button control unit 13a, a contact manipulation detection unit 13b, a manipulation face image display unit 13c, and a processing unit 13d, as shown in FIG. 1. Some or all of the units may be realized by hardware.

The physical button control unit 13a forms the physical button B to be contact-manipulated by the user in the partial region A of the obverse side (the physical button formation portion 11a) of the display unit 11. For example, the physical button control unit 13a controls the actuator (not shown), thereby deforming the partial region A such that the physical button B (one example of the manipulation unit of the present disclosure) to be contact-manipulated by the user is formed in the partial region A of the obverse side (the physical button formation portion 11a) of the display unit 11 or such that the partial region A, in which the physical button B is formed, is returned to an original state (e.g., a flat state) before formation of the physical button B. The physical button B may be a convex button or a concave button.

The contact manipulation detection unit 13b detects a contact manipulation (e.g., a touch or a press via the touch panel 11c) of the user on the physical button B.

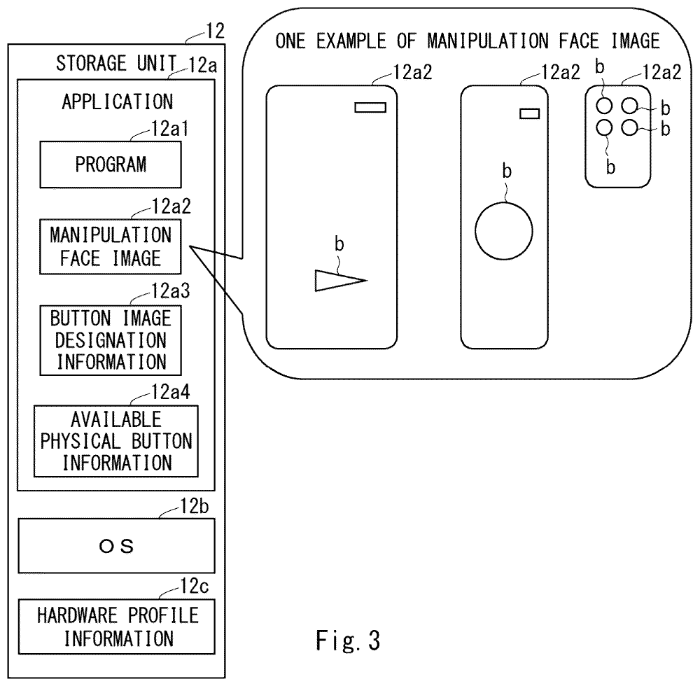

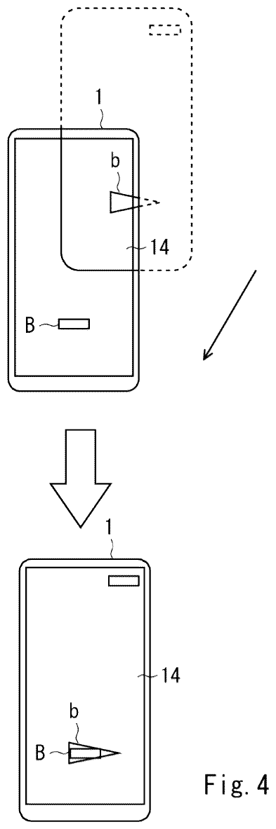

The manipulation face image display unit 13c displays the manipulation face image 12a2 (e.g., the manipulation face image 12a2 selected by the user) on the display 11b (the display screen) in a state where the button image b designated by the button image designation information 12a3 is aligned so as to coincide with the physical button B. FIG. 4 is a view representing how the manipulation face image 12a2 is displayed on the display 11b (the display screen) in a state where the button image b designated by the button image designation information 12a3 is aligned so as to coincide with the physical button B.

The processing unit 13d executes a process corresponding to a contact manipulation detected by the contact manipulation detection unit 13b. A specific example of the process corresponding to the contact manipulation is a video or sound playback process, for example, if the button image b is a playback button image included in a remote control image. A specific example is a proper process corresponding to an input in an up-down or left-right direction tailored to the outer shape of a button in line with game progress, for example, if the button image b is a cross-shaped button image displayed together with a game image. A specific example is a process of closing a window image, for example, if the button image b is a button image for closing the window image which is included in the window image.

Operational example 1 (an image display method) of the information processing apparatus 1 with the above-described configuration will be described.

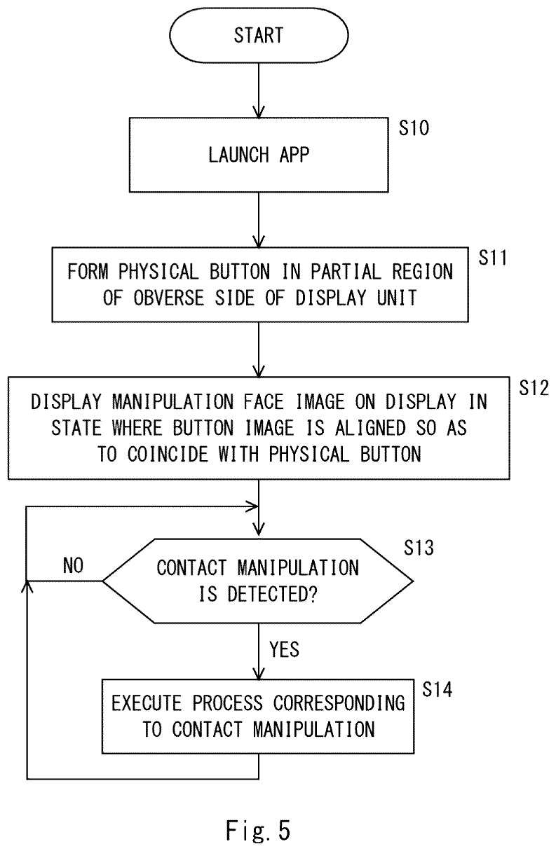

FIG. 5 is a flowchart of operational example 1 (the image display method) of the information processing apparatus 1.

The process below is executed mainly by the processor executing the OS 12b and the program 12a1 that are loaded from the storage unit 12 into the memory 14 (e.g., the RAM).

First, the app 12a is launched (step S10). The app 12a is launched through a predetermined user manipulation on the information processing apparatus 1. At this time, the user may be allowed to select the manipulation face image 12a2 to be aligned with the physical button B to be formed in the partial region A of the obverse side (the physical button formation portion 11a) of the display unit 11 from among a plurality of manipulation face images 12a2. The selection from among the plurality of manipulation face images 12a2 is made through, for example, a manipulation on a group of images in thumbnailed form which are lined up on the screen or a tabbed window.

The physical button B (see FIG. 2) is formed in the partial region A of the obverse side (the physical button formation portion 11a) of the display unit 11 (step S11). This is realized by the physical button control unit 13a. The physical button control unit 13a controls the actuator, thereby deforming the partial region

A such that the physical button B to be contact-manipulated by the user is formed in the partial region A of the obverse side (the physical button formation portion 11a) of the display unit 11. With this deformation, the physical button B (see FIG. 2) is formed in the partial region A of the obverse side (the physical button formation portion 11a) of the display unit 11.

The manipulation face image 12a2 (e.g., the selected manipulation face image 12a2) is displayed on the display 11b (the display screen) in a state where the button image b is aligned so as to coincide with the physical button B (step S12, see FIG. 4). This is realized by the manipulation face image display unit 13c.

Specifically, the manipulation face image display unit 13c displays the manipulation face image 12a2 on the display 11b (the display screen) in a state where the button image b designated by the button image designation information 12a3 is aligned as described above so as to coincide with the physical button B formed in the partial region A of the obverse side (the physical button formation portion 11a) of the display unit 11 (see FIG. 4).

It is judged whether a contact manipulation of the user on the physical button B is detected (step S13). This is realized by the contact manipulation detection unit 13b.

If it is judged as a result of the judgment in step S13 that a contact manipulation of the user on the physical button B is detected (YES in step S13), a process corresponding to the contact manipulation is executed (step S14). This is realized by the processing unit 13d. The processing unit 13d executes the process corresponding to the contact manipulation detected by the contact manipulation detection unit 13b.

After that, the processes in steps S13 and S14 are repeatedly executed.

Operational example 2 (an image display method) of the information processing apparatus 1 with the above-described configuration will be described.

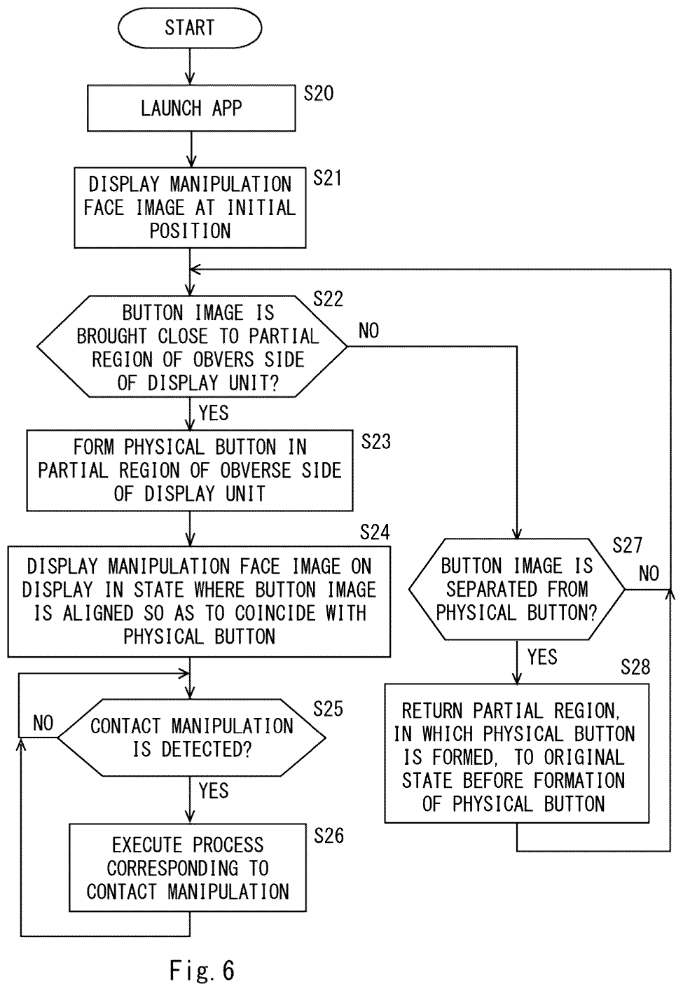

FIG. 6 is a flowchart of operational example 2 (the image display method) of the information processing apparatus 1.

The process below is executed mainly by the processor executing the OS 12b and the program 12a1 that are loaded from the storage unit 12 into the memory 14 (e.g., the RAM).

First, the app 12a is launched (step S20). The app 12a is launched through a predetermined user manipulation on the information processing apparatus 1. At this time, the user may be allowed to select the manipulation face image 12a2 to be aligned with the physical button B to be formed in the partial region A of the obverse side (the physical button formation portion 11a) of the display unit 11 from among a plurality of manipulation face images 12a2.

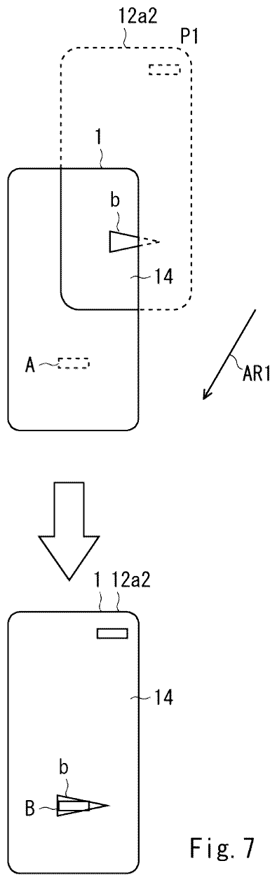

The manipulation face image 12a2 (e.g., the selected manipulation face image 12a2) is displayed at an initial position (step S21). For example, the manipulation face image 12a2 is displayed at an initial position P1, as shown in FIG. 7. FIG. 7 is a view representing how the manipulation face image 12a2 is displayed on the display 11b (the display screen) in a state where the button image b designated by the button image designation information 12a3 is aligned so as to coincide with the physical button B.

The user moves the manipulation face image 12a2 displayed at the initial position Pl within the display 11b (the display screen) toward the partial region A of the obverse side (the physical button formation portion 11a) of the display unit 11 in accordance with a user manipulation (see an arrow ARI in FIG. 7). That is, the manipulation face image 12a2 is an image which is movable within the display 11b (the display screen) in accordance with a user manipulation. Note that although the initial position P1 is set at the upper right for sake of explanation in FIG. 7, the initial position P1 is not limited to this. Although movement of the manipulation face image 12a2 based on a user manipulation is typically made through, e.g., a slide which is a touch manipulation, the movement may be made through a manipulation which fillips the manipulation face image 12a2 with, e.g., a flick.

It is judged whether the button image b included in the manipulation face image 12a2 that moves in accordance with the user manipulation as described above is brought close to the partial region A of the obverse side (the physical button formation portion 11a) of the display unit 11 (step S22).

If it is judged as a result of the judgment in step S22 that the button image b included in the manipulation face image 12a2 that moves in accordance with the user manipulation is brought close to the partial region A of the obverse side (the physical button formation portion 11a) of the display unit 11 (YES in step S22), the physical button B (see FIG. 2) is formed in the partial region A of the obverse side (the physical button formation portion 11a) of the display unit 11 (step S23). This is realized by the physical button control unit 13a. The physical button control unit 13a controls the actuator, thereby deforming the partial region A such that the physical button B to be contact-manipulated by the user is formed in the partial region A of the obverse side (the physical button formation portion 11a) of the display unit 11. With this deformation, the physical button B (see FIG. 2) is formed in the partial region A of the obverse side (the physical button formation portion 11a) of the display unit 11.

The manipulation face image 12a2 is displayed on the display 11b (the display screen) in a state where the button image b is aligned so as to coincide with the physical button B (step S24). This is realized by the manipulation face image display unit 13c. Specifically, the manipulation face image display unit 13c displays the manipulation face image 12a2 on the display 11b (the display screen) in a state where the button image b designated by the button image designation information 12a3 is aligned as described above so as to coincide with the physical button B formed in the partial region A of the obverse side (the physical button formation portion 11a) of the display unit 11 (see FIG. 7).

It is judged whether a contact manipulation of the user on the physical button B is detected (step S25). This is realized by the contact manipulation detection unit 13b.

If it is judged as a result of the judgment in step S25 that a contact manipulation of the user on the physical button B is detected (YES in step S25), a process corresponding to the contact manipulation is executed (step S26). This is realized by the processing unit 13d. The processing unit 13d executes the process corresponding to the contact manipulation detected by the contact manipulation detection unit 13b.

On the other hand, if it is judged as a result of the judgment in step S22 that the button image b included in the manipulation face image 12a2 that moves in accordance with the user manipulation is not brought close to the partial region A of the obverse side (the physical button formation portion 11a) of the display unit 11 (NO in step S22), it is judged whether the button image b included in the manipulation face image 12a2 that moves in accordance with the user manipulation is separated from the physical button B formed in the partial region A of the obverse side of the display unit 11 (step S27).

If it is judged as a result of the judgment that the button image b included in the manipulation face image 12a2 that moves in accordance with the user manipulation is separated from the physical button B formed in the partial region A of the obverse side (the physical button formation portion 11a) of the display unit 11 (YES in step S27), the partial region A, in which the physical button B is formed, is returned to an original state (e.g., a flat state) before formation of the physical button B (step S28). This is realized by the physical button control unit 13a. The physical button control unit 13a controls the actuator, thereby deforming the partial region A such that the partial region A, in which the physical button B is formed, is returned to the original state before formation of the physical button B.

After that, the processes in step S22 and the subsequent steps are repeatedly executed.

Operational example 3 (an image display method) of the information processing apparatus 1 with the above-described configuration will be described.

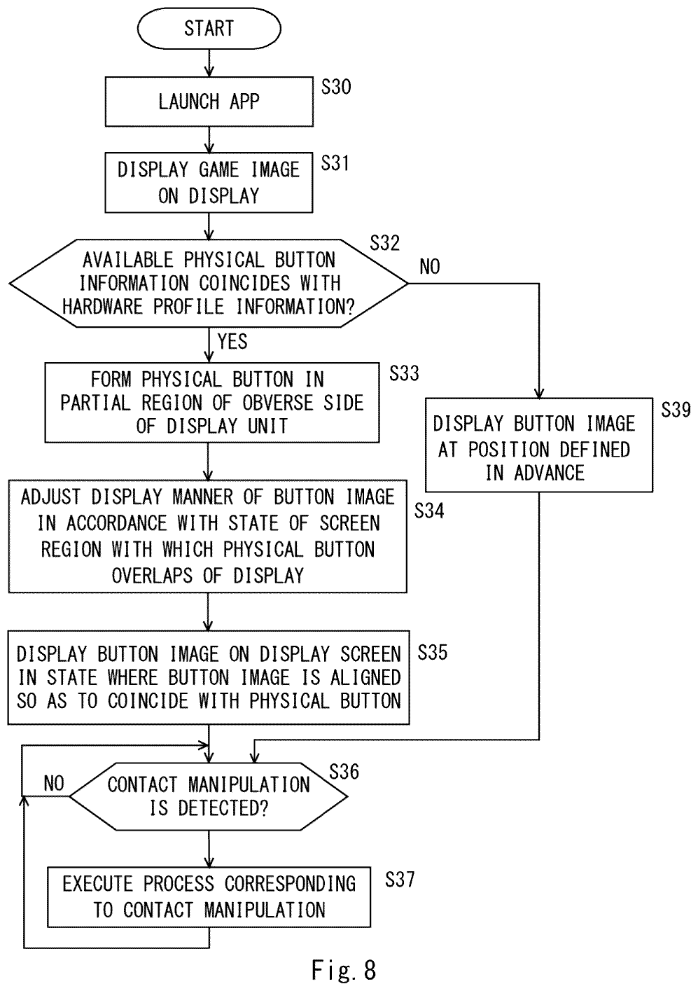

FIG. 8 is a flowchart of operational example 3 (the image display method) of the information processing apparatus 1.

The process below is executed mainly by the processor executing the OS 12b and the program 12a1 that are loaded from the storage unit 12 into the memory 14 (e.g., the RAM).

An example where the app 12a (the program 12a1) stored in the storage unit 12 is a game program will be described below as a premise.

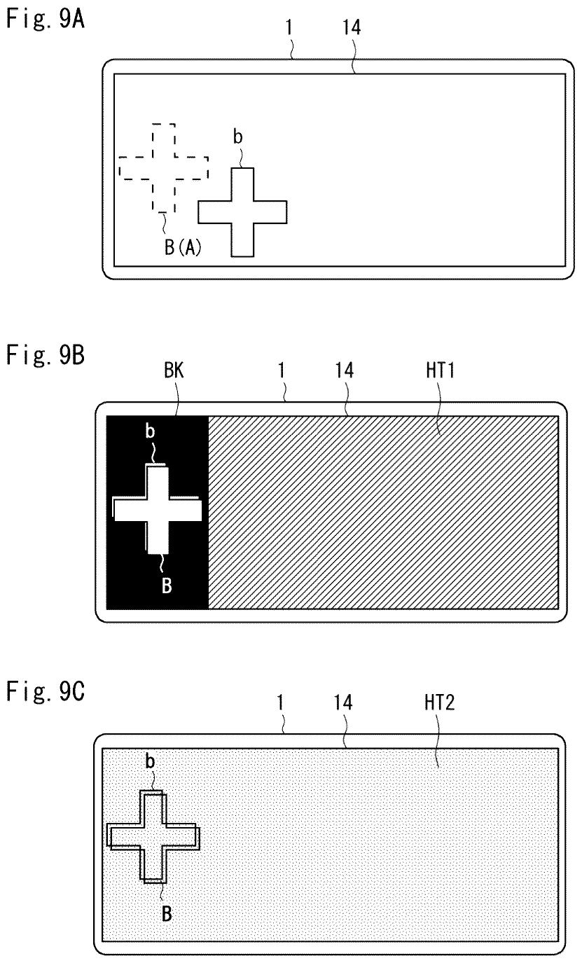

The physical button B to be formed in the partial region A of the obverse side (the physical button formation portion 11a) of the display unit 11 that is to be used in operational example 3 is a cross-shaped button which is generally used in, e.g., a game controller (see FIG. 9A). The button image b to be used in operational example 3 is a cross-shaped button image (see FIG. 9A). A game image is one example of a main image of the present disclosure, and a black-belt region is one example of a region for other than the main image of the present disclosure.

First, the app 12a is launched (step S30). The app 12a is launched through a predetermined user manipulation on the information processing apparatus 1.

A game image (one example of a specific image of the present disclosure) is displayed on the display 11b (the display screen) (step S31). As the game image, a game image of every kind of game (e.g., an action game, a shooting game, a simulation game, a racing game, an adventure game, or a role-playing game) is displayed in accordance with the launched app 12a. FIG. 9B shows one example of a game image HT1 which is displayed in a partial region of the display 11b (the display screen). In a portion denoted by reference character BK in FIG. 9B, a portion other than the main game image HT1 is indicated by a so-called black-belt region. FIG. 9C shows one example where a game image HT2 is displayed across an entire region of the display 11b (the display screen).

To judge whether the physical button B to be formed in the partial region A of the obverse side of the display unit 11 is available to the app 12a, it is judged whether the available physical button information 12a4 coincides with the hardware profile information 12c (step S32).

If it is judged as a result of the judgment in step S32 that the available physical button information 12a4 coincides with the hardware profile information 12c (YES in step S32), the physical button B (the cross-shaped button) is formed in the partial region A of the obverse side (the physical button formation portion 11a) of the display unit 11 (step S33). This is realized by the physical button control unit 13a. The physical button control unit 13a controls the actuator, thereby deforming the partial region A such that the physical button B to be contact-manipulated by the user is formed in the partial region A of the obverse side (the physical button formation portion 11a) of the display unit 11. With this deformation, the physical button B is formed in the partial region A of the obverse side (the physical button formation portion 11a) of the display unit 11.

The button image b is aligned with a screen region with which the physical button B overlaps of the display 11b (the display screen), and a display manner of the button image b to be displayed on the display 11b (the display screen) is adjusted in accordance with a state of the screen region (i.e., a screen region behind the physical button B) (step S34).

For example, if the screen region, with which the physical button B overlaps, of the display 11b (the display screen) is the black-belt region BK (see FIG. 9B), the display manner of the button image b is adjusted so as to highlight (e.g., blinkingly display or display in an enlarged view) the button image b. In this manner, the appearance of the physical button B can be changed without affecting game progress.

For example, if the screen region, with which the physical button B overlaps, of the display 11b (the display screen) is the game image HT2 (see FIG. 9C), the display manner of the button image b is adjusted so as to make the button image b transparent (the word means not only fully transparent but also semi-transparent and the like). The display manner may be adjusted so as to display the button image b with transparency adjusted. At the time of making the button image b transparent, the whole button image may be made transparent or the button image may be made transparent with a faint outline left. In this case, since the screen region (the game image HT2) behind the physical button B can be visually recognized without being covered with the button image b, game progress can be prevented from being affected.

The button image b is displayed on the display 11b (the display screen) in a state where the button image b is aligned so as to coincide with the physical button B (step S35). Specifically, the button image b, the display manner of which is adjusted as described above, is displayed on the display 11b (the display screen) in a state where the button image b is aligned as described above so as to coincide with the physical button B formed in the partial region A of the obverse side (the physical button formation portion 11a) of the display unit 11.

It is judged whether a contact manipulation of the user on the physical button B is detected (step S36). This is realized by the contact manipulation detection unit 13b.

If it is judged as a result of the judgment in step S36 that a contact manipulation of the user on the physical button B is detected (YES in step S36), a process corresponding to the contact manipulation is executed (step S37). This is realized by the processing unit 13d. The processing unit 13d executes the process corresponding to the contact manipulation detected by the contact manipulation detection unit 13b.

After that, the processes in steps S36 and S37 are repeatedly executed.

On the other hand, if it is judged as a result of the judgment in step S32 that the available physical button information 12a4 does not coincide with the hardware profile information 12c (it is judged that the available physical button information 12a4 does not coincide with the hardware profile information 12c, for example, if there is no information about a cross-shaped button among button images in the available physical button information 12a4) (NO in step S32), a button image is displayed at a position defined in advance without forming the physical button B (the cross-shaped button) in the partial region A of the obverse side (the physical button formation portion 11a) of the display unit 11 (step S39).

After that, similarly to the above, the processes in steps S36 and S37 are repeatedly executed.

Note that the process in step S32 above may be executed in operational example 1 above. In operational example 1, the idea of executing the process in step S32 above, for example, between step S10 and step S11 is conceivable. Similarly, the process in step S32 above may be executed in operational example 2 above. In operational example 2, the idea of executing the process in step S32 above, for example, between step S22 and step S23 is conceivable.

As has been described above, according to the embodiment, an image (e.g., the manipulation face image 12a2 including the manipulation image b in operational example 1 or 2 or the button image b in operational example 3) can be displayed in relation to the physical button B (one example of the manipulation unit of the present disclosure) to be formed in the partial region A of the obverse side (the physical button formation portion 11a) of the display unit 11.

Modifications will be described.

A user may switch between formation and non-formation of the physical button B.

For example, a dedicated physical key (not shown) may be provided in the information processing apparatus 1, and the user may switch between formation and non-formation of the physical button B in accordance with a manipulation of the user on the dedicated physical key. If there are a plurality of physical buttons B, a combination pattern forming physical buttons B to be formed in accordance with a manipulation of the user on the dedicated physical key may be cyclicly switched.

Switching between formation and non-formation of the physical button B may be conducted in accordance with the orientation of the information processing apparatus 1.

For example, if the information processing apparatus 1 is detected to be in landscape orientation (see, for example, FIG. 9A), the physical button B may be set to be formed at a left end, as shown in FIG. 9A. On the other hand, if the information processing apparatus 1 is detected to be in portrait orientation (see, for example, FIG. 7), the physical button B may be set not to be formed. Note that, if the information processing apparatus 1 is detected to be in portrait orientation (see, for example, FIG. 7), the button image b that is not aligned may be displayed at an initial position.

Standard rules may be set on the physical button B. Since a position of the physical button B is tactile, the user is allowed to more easily conduct such as a blind manipulation.

For example, if the physical button B is formed at an upper right corner of the display 11b (the physical button formation portion 11a), the physical button B may have a function of a button for closing a window image.

For example, if the long physical button B is formed at a right end of the display 11b (the physical button formation portion 11a), the physical button B may have a volume UP/DOWN function.

An object to be moved is not limited to the button image b, and, for example, a QR Code (R) on a browser screen may be moved to a specific position (e.g., an outer-frame position of the formed physical button B). Positioning of a QR Code within a determined frame for blind people facilitates a manipulation, such as passing a smartphone over a QR Code reading terminal apparatus.

A place to be pulled in may be changed in accordance with an attribute and presence or absence of pressure sensing in the physical button B. For example, a cross-shaped button and a stick-shaped button can be differently used. Alternatively, for example, a touch manipulation and a push-in manipulation based on pressure sensing can be suitably differently used.

Numerical values illustrated in the above embodiment are all illustrative, and proper numerical values different from the numerical values can, of course, be used.

The embodiment is merely illustrative in all respects. The present disclosure should not be limitedly interpreted by the description of the embodiment. The present disclosure can be implemented in various other forms without departing from the spirit and main features thereof.

While the invention has been described in terms of several embodiments, those skilled in the art will recognize that the invention can be practiced with various modifications within the spirit and scope of the appended claims and the invention is not limited to the examples described above. Further, the scope of the claims is not limited by the embodiments described above. Furthermore, it is noted that, Applicant's intent is to encompass equivalents of all claim elements, even if amended later during prosecution.

What is claimed is:

1. An image display method, wherein
an information processing apparatus including a display unit provided with a display and a touch panel and a control unit configured to form a manipulation unit to be contact-manipulated by a user in a partial region of an obverse side of the display unit, the display including a display screen on which a manipulation face image including at least one manipulation image is to be displayed, the touch panel being configured to detect a contact manipulation of the user on the manipulation image, comprises
a manipulation unit control step of deforming the partial region such that the manipulation unit is formed in the partial region or such that the partial region, in which the manipulation unit is formed, is returned to an original state before formation of the manipulation unit,
a manipulation face image display step of displaying the manipulation face image on the display screen in a state where the manipulation image is aligned so as to coincide with the manipulation unit, and
a contact manipulation detection step of detecting the contact manipulation of the user on the manipulation unit.

2. The image display method according to claim 1, wherein a manipulation image to be aligned with the manipulation unit is a manipulation image designated by manipulation image designation information of the manipulation image included in the manipulation face image.

3. The image display method according to claim 1, further comprising a step of allowing the user to select a manipulation face image to be aligned with the manipulation unit from among a plurality of manipulation face images.

4. The image display method according to claim 1, wherein the manipulation face image is an image which is movable within the display screen in accordance with a user manipulation,
if the manipulation face image moves in accordance with a user manipulation, and the manipulation image included in the manipulation face image is brought close to the manipulation unit,
the manipulation unit control step deforms the partial region such that the manipulation unit is formed in the partial region, and
the manipulation face image display step displays the manipulation face image on the display screen in a state where the manipulation image is aligned so as to coincide with the manipulation unit, and
if the manipulation face image moves in accordance with a user manipulation, and the manipulation image included in the manipulation face image is separated from the manipulation unit,
the manipulation unit control step deforms the partial region such that the partial region, in which the manipulation unit is formed, is returned to an original state before formation of the manipulation unit.

5. The image display method according to claim 1, wherein the manipulation image is a button image.

6. The image display method according to claim 1, further comprising a judgment step of judging based on available manipulation unit information regarding an available manipulation unit and hardware profile information regarding the manipulation unit whether the manipulation unit is available, and
the manipulation unit control step deforms the partial region such that the manipulation unit is formed in the partial region if the manipulation unit is judged to be available.

7. The image display method according to claim 6, wherein the available manipulation unit information includes information regarding a location, operation, and an attribute of the available manipulation unit.

8. The image display method according to claim 7, wherein the attribute includes information representing a type of the available manipulation unit and information representing presence or absence of pressure sensing in the available manipulation unit.

9. The image display method according to claim 1, further comprising a display manner change step of adjusting a display manner of the manipulation image to be displayed on the display screen in accordance with a state of a screen region, in which the manipulation unit overlaps with the specific image, of the display screen, and
a manipulation face image display step of displaying the manipulation image after adjustment of the display manner on the display screen in a state where the manipulation image is aligned so as to coincide with the manipulation unit.

10. The image display method according to claim 9, wherein
the manipulation image is a button image, and
the specific image is a game image.

11. The image display method according to claim 9, wherein the display manner change step changes the display manner so as to highlight the manipulation image if the screen region, with which the manipulation unit overlaps, of the display screen is a region for other than a main image.

12. The image display method according to claim 9, wherein the display manner change step changes the display manner so as to adjust transparency of the manipulation image and display the manipulation image if the screen region, with which the manipulation unit overlaps, of the display screen has the specific image.

13. An information processing apparatus comprising:
a display unit provided with a display and a touch panel and a control unit configured to form a manipulation unit to be contact-manipulated by a user in a partial region of an obverse side of the display unit, the display including a display screen on which a manipulation face image including at least one manipulation image is to be displayed, the touch panel being configured to detect a contact manipulation of the user on the manipulation image;
a manipulation unit control unit configured to deform the partial region such that the manipulation unit is formed in the partial region or such that the partial region, in which the manipulation unit is formed, is returned to an original state before formation of the manipulation unit;
a manipulation face image display unit configured to display the manipulation face image on the display screen in a state where the manipulation image is aligned so as to coincide with the manipulation unit; and
a contact manipulation detection unit configured to detect a contact manipulation of the user on the manipulation unit.

14. The information processing apparatus according to claim 13, further comprising a judgment unit configured to judge based on available manipulation unit information regarding an available manipulation unit and hardware profile information regarding the manipulation unit whether the manipulation unit is available, and
the manipulation unit control unit configured to deform the partial region such that the manipulation unit is formed in the partial region if the manipulation unit is judged to be available.

15. The information processing apparatus according to claim 13, further comprising a display manner change unit configured to adjust a display manner of the manipulation image to be displayed on the display screen in accordance with a state of a screen region, in which the manipulation unit overlaps with the specific image, of the display screen, and
a manipulation face image display unit configured to display the manipulation image after adjustment of the display manner on the display screen in a state where the manipulation image is aligned so as to coincide with the manipulation unit.

16. The information processing apparatus according to claim 14, further comprising a display manner change unit configured to adjust a display manner of the manipulation image to be displayed on the display screen in accordance with a state of a screen region, in which the manipulation unit overlaps with the specific image, of the display screen, and
a manipulation face image display unit configured to display the manipulation image after adjustment of the display manner on the display screen in a state where the manipulation image is aligned so as to coincide with the manipulation unit.

17. The image display method according to claim 6, further comprising a display manner change step of adjusting a display manner of the manipulation image to be displayed on the display screen in accordance with a state of a screen region, in which the manipulation unit overlaps with the specific image, of the display screen, and
a manipulation face image display step of displaying the manipulation image after adjustment of the display manner on the display screen in a state where the manipulation image is aligned so as to coincide with the manipulation unit.
